(19) United States
(12) Patent Application Publication
(10) Pub. No.: US 2003/0078882 A1
(43) Pub. Date: Apr. 24, 2003

(54) Smart cards, customer relationship management system and method of offering results of customer analysis

(76) Inventors: Hiroko Sukeda, Tokorozawa (JP); Masahiro Kaminaga, Sakado (JP); Kazuhiro Oozeki, Kawasaki (JP); Kazuo Fujita, Fujisawa (JP); Chiaki Matsumoto, Yokohama (JP); Nobuo Nagai, Yokohama (JP); Kunio Suzuki, Kashiwa (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/068,984

(22) Filed: Feb. 11, 2002

(30) Foreign Application Priority Data
Oct. 23, 2001 (JP) 2001-324356

(51) Int. Cl. G06F 17/60

(52) U.S. Cl. 705/39

(57) ABSTRACT

A loyalty program using a smart card enables realtime customer information analysis at a shop. Customer services are improved by conveniently and realtime providing results of analyzing each customer's usage status and tendency. A smart card application program analyzes customer information. Since the smart card has just a limited capacity and calculation capability, the card is incapable of complicated calculation and storing a large amount of log data. To solve this problem, a recurrence formula is used for calculating a value representing the customer's buying habit. There is provided a plurality of parameters needed for the calculation in order to enable determination of loyal customers according to different evaluation criteria such as a score based on the most recent purchase amount or the continuity. In addition, a shop card is used for point management to more economically enable customer information analysis at shops.

### BACKGROUND OF THE INVENTION

The present invention relates to smart cards, a customer relationship management system and a method of offering results of customer analysis. Specifically, the present invention relates to a computer system with high security and more particularly to a computer system centering on a smart card capable of storing an application program in nonvolatile memory. More specifically, the present invention is concerned with a customer information system for analyzing the customer's purchase data and improving services for customers.

A smart card contains a CPU (Central Processing Unit) on an IC chip and enables operations in the card. Since the smart card has an improved information storage capability and provides high-level security, it is expected to be used in various fields, and is positively introduced especially into the financial field such as electronic money in recent years.

Particularly, a multiapplication-compliant smart card is managed by a card OS (Operating System) capable of installing a plurality of applications on a single card and is controlled to ensure high independence between application programs. The multiapplication-compliant smart card can not only allow a plurality of application programs to safely coexist, but also add new application programs to the card after issuance and delete unnecessary application programs. Namely, the smart card can be considered to be not only a data storage medium, but also a secure computer. The multiapplication-compliant smart card is expected to be used in the financial field such as credit cards, electronic money, etc. especially, with respect to cooperation between a plurality of applications from the viewpoint of making the most of card security and replacing the conventional magnetic card capability.

Conventionally, there has been adopted a so-called loyalty program as a general means for retaining customers. The loyalty program is defined as a system which accumulates points in accordance with user's usage log data and provides specified services based on the accumulated points. This system aims at promoting usage of shops and cards in expectation of benefits by collecting points. System examples include a stamp card for a shopping center, a loyalty program for a department store, a mileage program for an airline, etc. In the case of the loyalty program for department stores, for example, a member carries a card and presents it when he or she shops at that department store. In addition to the purchase log data, points are accumulated according to sales accounts. For example, 20 points are added for every purchase of 1,000 yen. A specified number of accumulated points can be exchanged for a gift certificate usable at that department store. For example, 1,000 points can be exchanged for a gift certificate equivalent to 1,000 yen. Namely, a member can get a 1,000 yen discount for purchase of 50,000 yen. During a sales campaign, points are added twice or a discount rate is increased when the purchase amount in a year reaches a specified amount, driving the consumers to buy. As another example, the mileage program for airlines accumulates a flight distance instead of a purchase amount. When a specified flight distance is reached, the system provides a free airline ticket or a service of upgrading the seat class. Also in this case, the system motivates members to use the same airline by providing services according to members' usage log data. In such loyalty programs, it is possible to safely provide a more flexible system by storing user's point information in a smart card and improve user-friendliness for users and system administrators. Further, the multiapplication-compliant smart card enables a plurality of applications to effectively cooperate with each other in combination with electronic money and a credit card capability.

These loyalty programs use tools for providing customers with better services by managing and analyzing customer's purchase data. Specifically, the system collects log data about usage of the shop by customers and provision of points on a server, etc. and calculates or analyzes the stored data to project marketing strategy or promote sales for individual customers. Since customer needs are diversified nowadays, it is very important to keep track of the usage trend of individual customers. RFM (Recency, Frequency, Monetary) analysis or the data mining technique is used to differentiate and compartmentalize customers for effective promotion. The concept of business practice to develop business satisfying-individual customers' needs is called CRM (Customer Relationship Management). Various systems are proposed in addition to development of the information system.

### SUMMARY OF THE INVENTION

A typical CRM system based on the loyalty program uses a reward card storing the customer's ID. A server collects data about when, at which shop, and, in some cases, what the customer purchased. The server analyzes the customer's usage status, buying habit, etc. The system provides promotion activity such as issuing DM (direct mail) according to the result. A very important step is to analyze each customer's usage log data and to rank customers for “differentiating” them according to the resulting buying habit.

Unless terminals at all shops are connected to the server realtime, however, it is difficult to obtain an up-to-date result of analyzing the customer information instantaneously reflecting the current usage at each shop, inevitably causing a time lag. When the system is designed to use points common to a plurality of shops rather than the loyalty program for a single shop, it is not practical to realtime connect shop terminals of all member stores. Considerable costs are required to obtain a realtime analysis result.

The present server-based CRM mainly provides promotion activity of issuing DM later based on the result of analyzing each customer's usage status and tendency on the server. Further, more fine-tuned customer services are available if each shop can “ad hoc” identify the customer's buying habit reflecting information about the most recent usage. For example, if a customer is found to frequently shop at the member store in recent days, it is highly possible that the customer lavishes money recently. The customer may do more shopping on the same day by giving him or her a parking ticket or a discount coupon for another member store, for example. If the customer remembers such a service, he or she may shop at the same store again in the future. There may be a case where a customer does not spend much money per purchase but frequently shops at the store many times. If this information is known, it is possible to promote this customer's loyalty by providing him or her with services for treating as a valued customer such as offering the preferential right to buy limited goods. It is important to conveniently provide these services at the shop where the customer does shopping at just the right moment. Namely, the realtime service is critical.

It is an object of the present invention to improve customer services by using the loyalty program as a tool for retaining customers to conveniently and realtime provide results of analyzing the usage status and tendency of individual customers.

To solve the aforementioned problems, the processing capability of the smart card is used to analyze the customer information inside the smart card.

A customer s reward card is replaced by the smart card installed with an application program which manages points and analyzes the customer information. A multiapplication-compliant smart card can be installed with a payment application as well to improve user-friendliness by making the most of card security.

An application program in the card analyzes the customer information. Considering the hardware performance, however, it is physically impossible to process and calculate a large amount of data on the card as conventionally implemented on the server. Although the smart card has a much larger storage capacity than a magnetic card, it is difficult to store all log data hitherto collected for respective customers. This is not practical from the viewpoint of costs. It is necessary to consider to use the card with a minimum storage capacity by reflecting the hitherto collected customer log data.

Purchase data about a customer generates a value representing the customer's buying habit or a degree of customer loyalty (hereafter referred to as a score) which changes over time. A progression including the passage of time can represent the relationship between the customer's purchase data and the score. It is possible to calculate a score value reflecting the past purchase data at the present moment just from the previous result and the most recent purchase data by using a recurrence formula which represents the relationship between a term and an adjacent term in the progression.

The purchase data to be used for calculation includes a purchase amount, a usage date, the number of usage, a purchase category, etc. Scores resulting from the calculation include the most recent purchase amount, usage frequency continuing usage, etc. By using the aforementioned purchase data and the recurrence formula, it is possible to calculate the accumulated number of usage, the accumulated purchase amount, the average number usage, the average purchase amount, etc.

It is possible to control to what degree the past purchase data should be reflected by changing parameters in the score formula. Further, it is possible to determine whether to find a score based on the purchase amount or on the number of usage by changing the selected item for usage information in the formula. Maintaining a plurality of parameters makes it possible to increase score types that can be calculated in the card.

It is a general practice to appropriately conduct promotion activity for customers at shops with reference to the calculated score values. Based on cooperation with the loyalty program, it is also possible to use the score values to vary the rate of points given to the customer's card according to his or her usage. When a multiapplication-compliant smart card is used, cooperation with a payment means enables a discount on the spot or further cooperation with other applications. It may be preferable to provide a shop terminal with a capability of promoting sales according to the score such as issuing an appropriate coupon.

Besides a customer-owned card, the conventional loyalty program may provide each shop with a smart card or an IC chip and use it to manage issuance of points. For example, in a paid-in-advance point system, issuable points are purchased in advance from a service provider. The IC chip stores the balance of issuable points. Each time a point is issued, the corresponding amount is subtracted. As another example, a paid-later point system stores a provided amount and log data on the IC chip each time a point is issued, and adjusts the amount as needed. An object to use the shop-use smart card or IC chip is to prevent an ill-intentioned clerk from tampering log data by illegally issuing points or from falsifying the amount of issuing points by means of the IC chip security. Instead of customers' cards, the shop-use smart card can be used to analyze and calculate the customer information by installing an application program for customer information analysis in the card. There are many cards owned by individual customers. Preferably, a customer's card is used to store not the program, but his or her current score value or parameters needed for calculation. The smart card (IC chip) for a shop terminal is used for program execution. The customer's card need not be intelligent, providing an effect of reducing costs for the entire system.

The following six items can be pointed out as means for solving the aforementioned problems by the present invention.

(1) A recurrence formula is used for representing the relationship between the customer's purchase data and a value representing his or her buying habit (a degree of customer loyalty), i.e. a score. This enables a score value to be calculated just from the previous result and the most recent purchase data.

(2) A program for performing the aforementioned calculation is installed on a smart card owned by the customer.

(3) The IC card also stores parameters for score calculation.

(4) There may be a method of varying the amount of points supplied to the customer's card according to the calculated score value.

(5) Further, there may be a method of providing a specified additional service such as issuing a coupon according to the calculated score value.

(6) Moreover, there may be a method of storing the previous calculation result of the score and parameters in the customer's card and installing a score calculation program in a smart card or an IC chip inserted into a shop terminal or in the shop terminal itself.

### BRIEF DESCRIPTION OF THE DRAWINGS

FIG. 1 exemplifies a system configuration of a general loyalty program using a smart card;

FIG. 2 describes an embodiment of the present invention, showing a configuration which provides a loyalty application of the smart card in FIG. 1 with a capability of analyzing the customer information;

FIG. 3 describes an embodiment of the present invention, showing a customer analysis mathematical formula;

FIG. 4 describes a calculation method of a formula (210) in FIG. 3 inside the card;

FIG. 5 describes a flow of processing for point provision in the system as shown in FIG. 2;

FIG. 6 shows an example of presenting an analysis result at step (320) in FIG. 5;

FIG. 7 illustrates a procedure for changing a point provision rate according to a rank determined by a result of analyzing the customer information;

FIG. 8 illustrates another embodiment of the present invention, showing a configuration diagram of a smart card loyalty program (using a shop card);

FIG. 9 illustrates still another embodiment of the present invention, showing a configuration diagram of a smart card loyalty program (customer information analysis using a shop card);

FIG. 10 illustrates still yet another embodiment of the present invention, describing a process of providing points (using a shop card);

FIG. 11 shows a system configuration for yet still another embodiment of the present invention; and

FIG. 12 shows a system configuration for still yet another embodiment of the present invention, describing a process of providing points.

### DESCRIPTION OF THE PREFERRED EMBODIMENTS

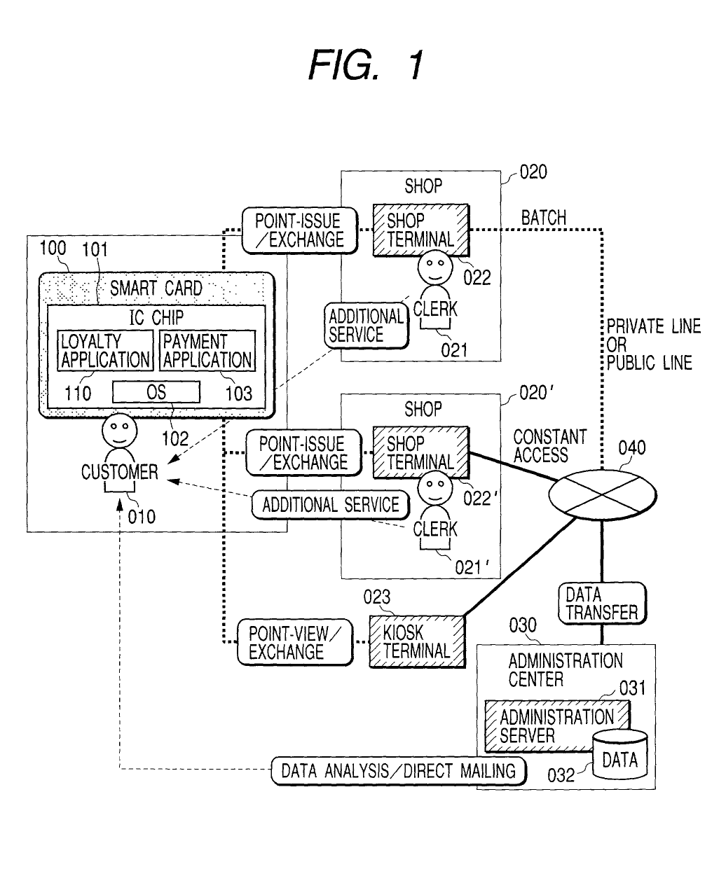

FIG. 1 exemplifies a system configuration of a general loyalty program using a smart card. The system comprises a smart card (100) owned by a customer (010), a shop terminal (022) installed at a shop (020) of each member store, and an administration server (031) in an administration center (030) which manages the entire system. There may be provided a KIOSK terminal (023) capable of processing the smart card as needed. This terminal is not indispensable for the loyalty program configuration.

The customer (010) owns the previously issued smart card (100) which is loaded with a loyalty application (110) running on a smart card OS (102). This example shows that a payment application (103) such as electronic money or credit and a loyalty application (110) used for this system are loaded independently. The payment application (103) need not necessarily coexist. The loyalty application (110) may be loaded alone. Alternatively, another application may be loaded.

Each member store's shop (020) is provided with at least one shop terminal (022) for processing the smart card (100). The shop terminal (022) is mainly operated by a clerk (021). The shop terminal can preferably process both the payment application (103) and the loyalty application (110) on the smart card (100). Depending on system requirements, different terminals may be used for respective applications. The shop terminal (022) is preferably, but not necessarily, connected to a cash register in the shop.

In the administration server (031), a data storage apparatus (032) stores customer information or point information in the system and information about shops. The shop terminal (022) at each shop is connected to the administration server (031) via a private or public line (040). The shop terminal can send or receive data as needed independently of a constant or batch access.

When the customer (010) uses the shop (020), the shop terminal (022) adds a point to the smart card (100). Log data about the customer (010) is sent from the shop terminal (022) to the administration server (031) at the administration center (030) via the line (040) and is stored in the database (032).

Point data stored in the loyalty application (110) of the smart card (100) can be exchanged for a gift certificate or a premium as needed at the shop (020) or the KIOSK terminal (023). An additional service may be provided according to the amount of points. The administration server (031) analyzes usage status of each customer stored in the customer database (032) and, based on the analysis result, conducts customer-based promotion such as issuing direct mail.

This system performs various analyses based on data sent to the server from respective shops and feeds back the result to the promotion. The system analyzes the total sales amount, shop-based sales status, season- or time-based sales status, etc. Generally, it is said to be particularly effective to analyze the usage status for respective customers and to conduct promotion suited for each customer. According to the one-to-one marketing concept, an effective marketing technique is to encourage each customer's loyalty and increase “loyal customers”. For example, it is necessary to promote a new frequent customer to continuously visit the shop in the future, a long-term loyal customer to remain to be loyal, and an estranged customer to revisit the shop.

Various techniques are available for customer analysis on the server and achieve effects. When the shop terminal (022) is not connected to the server (031) constantly, however, the database (032) on the server (031) does not always reflect the up-to-date information. In this case, the shop terminal may be connected to the server periodically, e.g., once a day or hourly. Alternatively, a batch access may be used to connect to the server as needed when the log data is accumulated as many as 100 entries, for example, and is transmitted to the server. It takes a long time to thoroughly analyze customer data on the server. An analysis result does not necessarily reflect the up-to-date status. Realtime promotion is not so important when sending direct mail to necessary customers, for example. However, when a result of calculation on the server should be realtime sent to the shop (020) for conducting the promotion at the shop according to the result, communication is required between the server and all shops, increasing loads. This is practically difficult.

Here, it is proposed to use the arithmetic capability of the smart card (100) for realtime analyzing the customer information at the shop (020).

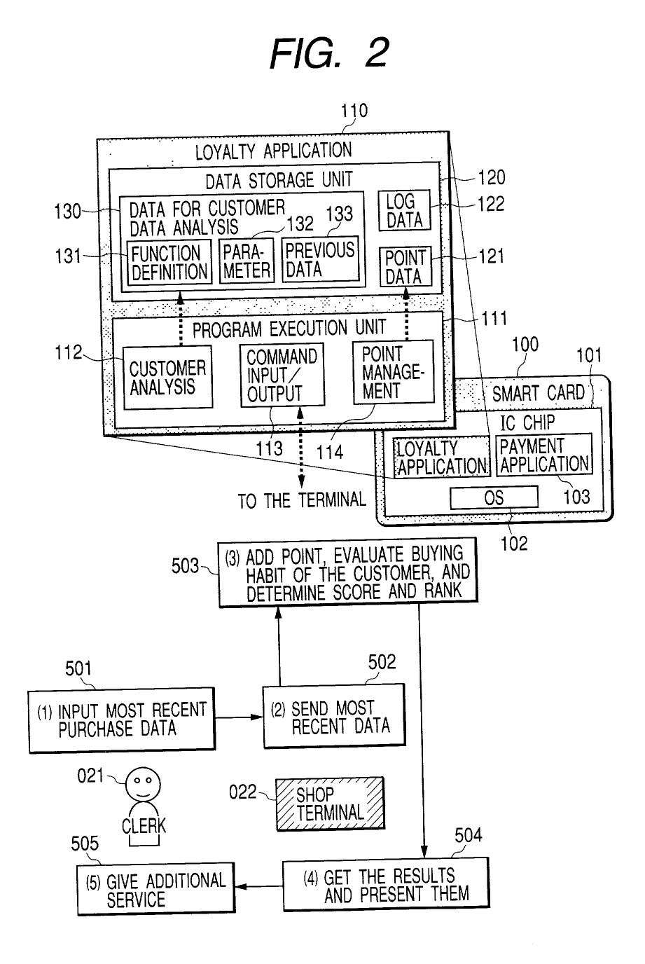

FIG. 2 shows the configuration which provides the loyalty application (110) of the smart card (100) with a capability of analyzing the customer information.

The loyalty application (110) comprises a program execution unit (111) and a data storage unit (120). The program execution unit (111) comprises a customer analysis unit (112), a command input/output unit (113), and a point management unit (114). The data storage unit (120) stores point data (121), log data (122), and data for customer data analysis (130). The data for customer data analysis (130) can be divided into a function definition unit (131), a parameter unit (132), and a previous data unit (133).

Generally, the application program on the smart card uses the command input/output unit (113) to process a command entered from the terminal. The application program performs predefined processing for the command and uses the command input/output unit (113) to returns a processing result to the terminal as a response. The loyalty application (110) in FIG. 2 processes points or analyzes customer data in response to a command from the terminal and returns a result corresponding to the command. The processing procedure is described below.

Step 1 (501): At the time of shopping, the clerk (021) enters purchase data (sales amount, amount of points provided, usage date, shop data, etc.) on the shop terminal (022).

Step 2 (502): The shop terminal (022) sends necessary input data to the loyalty application (110) of the smart card (100).

Step 3 (503): The loyalty application (110) uses the point management unit (114) to add points to the point data (121). The loyalty application then allows the customer analysis unit (112) to analyze the customer data by using the data for customer data analysis (130) and data sent from the terminal and returns an analysis result to the terminal.

Step 4 (504): The shop terminal (022) obtains a response from the card (100) and presents the result.

Step 5 (505): The clerk (021) provides the customer with an additional service according to the presented result.

The most important part of this system is a method of analyzing the customer information in the card at step 3 of this procedure. This is detailed below.

The smart card provides an unparalleled processing capability and memory capacity compared to a conventional magnetic card, but is physically incapable of analytical calculation equivalent to a server. With respect to the memory capacity, the smart card cannot store all transactional log data collected so far for respective customers while the server can do it. Accordingly, the smart card is incapable of complicated analysis comparable to the server.

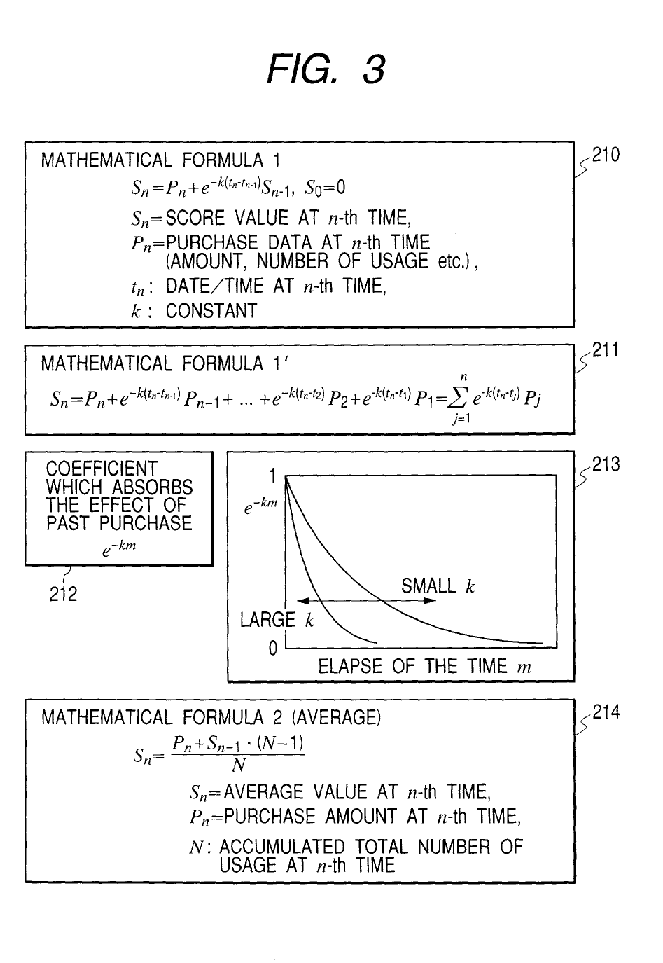

A solution is to use a recurrence formula like mathematical formula 1 (210) as shown in FIG. 3. In addition to a point stored in the card, a “score” is used to represent a buying habit of the customer so far. Given that Sn is a score value at the n-th time; an initial value is 0; Pn is purchase data (amount, number of usage etc.) at the n-th time; tn is a date/time at the n-th time; and k is a constant. Then, Sn is expressed as formula (210). This formula (210) is expanded to be equivalent to formula (211). This mathematical formula (211) signifies that an Sn value is equivalent to the accumulation of past purchase data by decreasing effects according to the passage of time. By expressing this mathematical formula with the recurrence formula (210), score value Sn at the n-th time can be found just by using previous score value Sn−1, previous date/time tn−1, most recent date/time tn, and most recent purchase data Pn.

Given that tn−ti=tm is an elapsed time from time point i to time point n, coefficient (212) attenuates with the lapse of time. Namely, as an elapsed time from a given time point to the present time point increases, an effect of purchase at that time point decreases. Chart (213) illustrates this. By changing values for constant k (206) and purchase data Pn, it is possible to calculate a different value as the score, i.e., the score according to a different evaluation measure. Increasing the value for k increases the rate of attenuation for (212) in FIG. 3. The score value reflects more recent usage status. Decreasing the value for k decreases the rate of attenuation. The score value reflects usage status for a longer term. In the aforementioned formula, when Pn takes the amount, the score value reflects the purchase amount. Given that Pn=1 per purchase, the score value reflects the number of usage independently of the purchase amount. (Another method assumes Pn=1 when the purchase amount exceeds a specified value.)

Changing values for constant k and Pn (hereafter generically referred to as “parameters”) controls the buying habit of a customer who gains a high score. Increasing k and placing the purchase amount in Pn makes a short list of customers who do expensive shopping recently. Decreasing k and placing the number of usage in Pn makes a short list of long-term customers. Since score values using different parameters need to be calculated for each purchase, the smart card stores several types of parameters and corresponding most recent score values in advance. More effective customer information analysis is available by allowing score values for necessary parameters as needed.

Mathematical formula 2 (214) uses a recurrence formula to find an average purchase amount per purchase. This formula does not use the coefficient (212), but the recurrence formula for finding the most recent result from the previous calculation result and the most recent data. Accordingly, the calculation requires a minimum memory capacity.

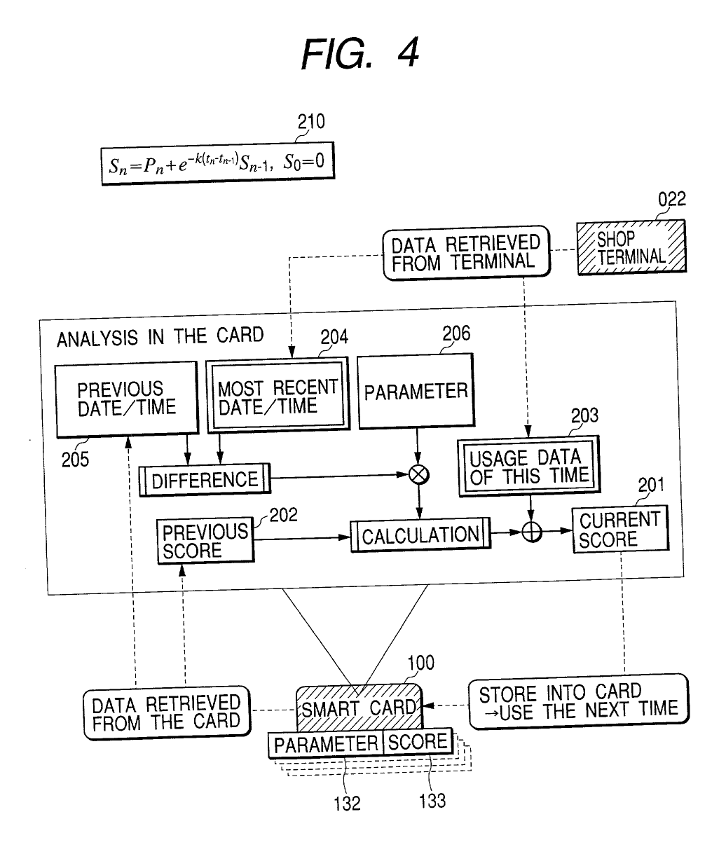

FIG. 4 shows the calculation method of formula (210) in FIG. 4 in the card. There is found a difference between a previous date/time (205) and a most recent date/time (204) obtained from the terminal (022). That difference is calculated by using a previous score (202) stored in the card (100) and the predetermined parameter (206). The result is added to the most recent purchase data (203) obtained from the terminal (022) to find a current score (201). The found score (201) is re-stored in the smart card (100) and is used for the next calculation. As mentioned above, it is recommended to prepare a plurality of parameters (132) and corresponding up-to-date score values (133) for calculating a plurality of scores based on different evaluation measures.

The methods described in FIGS. 3 and 4 make it possible to obtain a score value reflecting the most recent log data just from the previous calculation result and the most recent data. This is very useful when complicated calculation is impossible under the condition of a limited memory capacity such as the smart card.

Conventionally, an analysis result is based on less varying information such as “yearly purchase amount” or “the number usage per year”. By contrast, the method using formula (210) in FIG. 3 performs realtime calculation by using the coefficient which decreases effects with the passage of time. This system is particularly characterized in that a very simple method enables the fine-tuned analysis based on the dynamically varying evaluation measure such as “recent valued customers” or “long-term regular customers”.

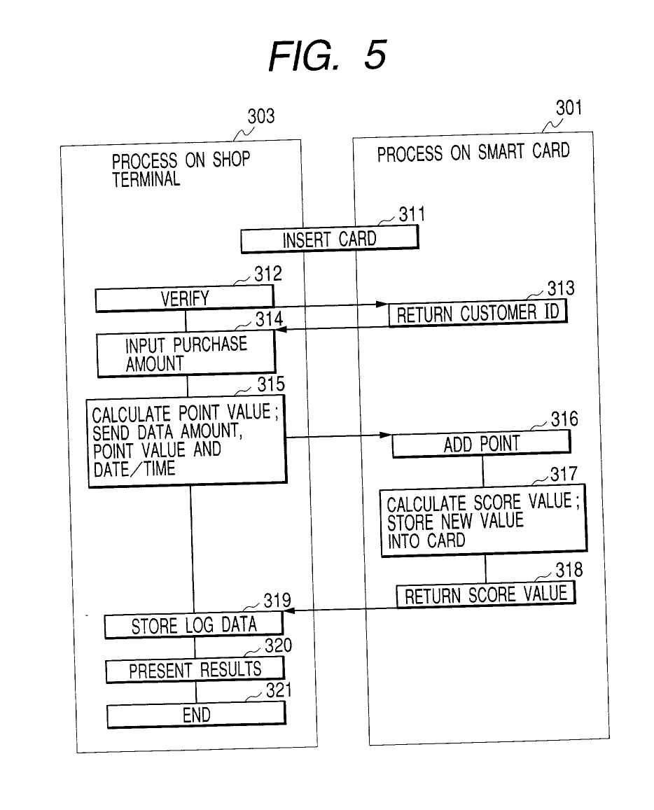

FIG. 5 shows a flow of providing points in the system in FIG. 2.

When the smart card (100) is inserted into the shop terminal (022) (step 311), the shop terminal performs authentication of the card (Verify) (step 312). When the authentication is complete, the card returns a customer ID to the terminal (step 313). The terminal then inputs a purchase amount (step 314), calculates a point value, and sends the input purchase amount, the point value to be provided, and the current date/time to the card (step 315) After adding the point (step 316), the card calculates the most recent score and stores a new score value according to the methods described in FIGS. 3 and 4. Here, the key to the score calculation at step (317) is to obtain the most recent result by using the previous result and the most recent purchase data. An actual mathematical formula is not limited to formula (210) or (214) in FIG. 3. The card returns the calculated score value to the terminal to complete the processing (step 318). The terminal stores log data (step 319), displays the analysis result (step 320), and terminates the processing (step 321).

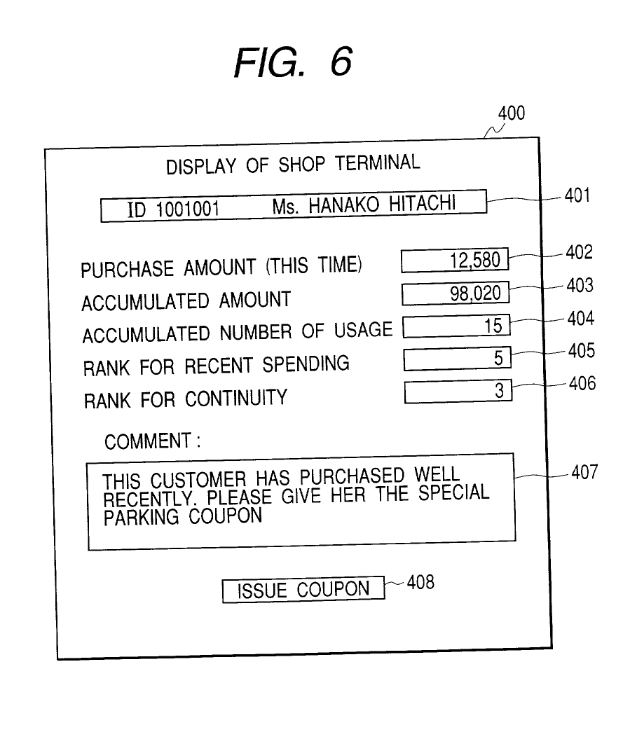

FIG. 6 is an example of displaying an analysis result at step (320) in FIG. 5., A shop terminal's screen (400) displays a result of the customer information analyzed in the smart card. Items to be displayed are basic data such as a customer's ID and name (401) as well as, e.g., most recent purchase amount (402), accumulated purchase amount (403), accumulated number of usage (404), rank for recent spending (405), and rank for continuity (406). In addition, a comment (407) is displayed corresponding to this result. This example shows “a customer who is higher in rank of recent spending rather than that of continuity” according to the rank for recent spending (405) and the rank for continuity (406). The comment (407) prompts the clerk to provide an additional service by issuing a special coupon. For this purpose, there may be provided a button (408) for issuing a necessary coupon. In this example, the button for issuing coupons is not indispensable and just assists the clerk with promotion.

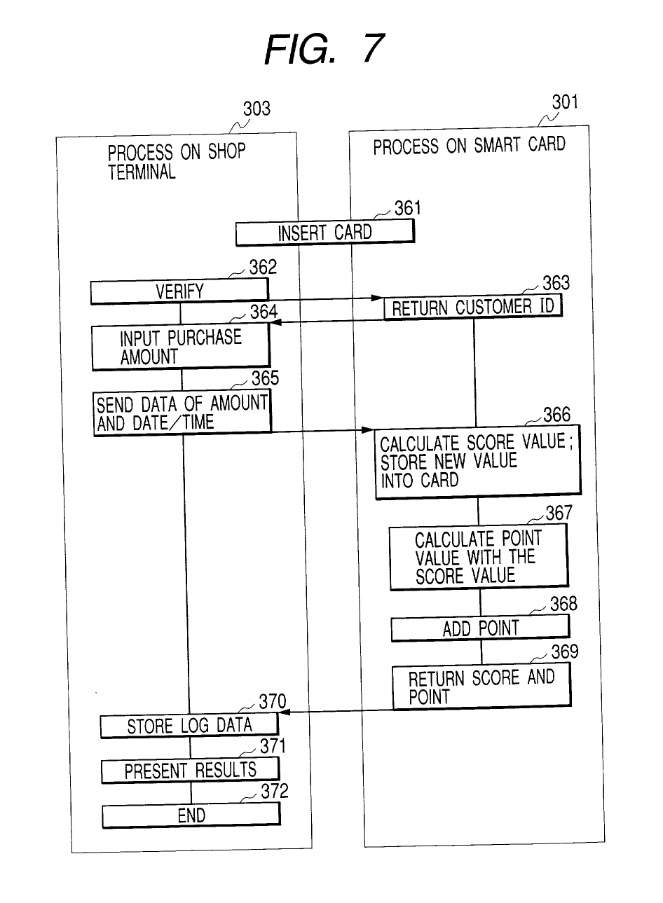

From the viewpoint of enriching services for valued customers, there may be a system which adjusts point values to be added to the customer s card based on the result of customer information analysis. FIG. 7 illustrates a procedure of changing the point provision rate according to a rank determined by the result of customer information analysis.

When the smart card is inserted into the shop terminal (step 361), the shop terminal performs the authentication of the card (step 362). Upon completion of the authentication, the card returns a customer ID to the terminal (step 363). The terminal then inputs a purchase amount (step 364) and sends purchase data such as the purchase amount and the current date/time to the smart card (step 365).

Using these pieces of data, the card calculates the most recent score and stores a new score value (step 366). The card then determines a point amount to be added according to this score value (step 367) and adds points (step 368). The card returns the calculated score value and the point amount to the terminal (step 369). The terminal stores log data (step 370), displays the analysis result (step 371), and then terminates processing (step 372).

There have been described the calculation method of analyzing the customer data using the smart card and the method of analysis calculation inside the customer's smart card by using the example with reference to FIGS. 1 through 7.

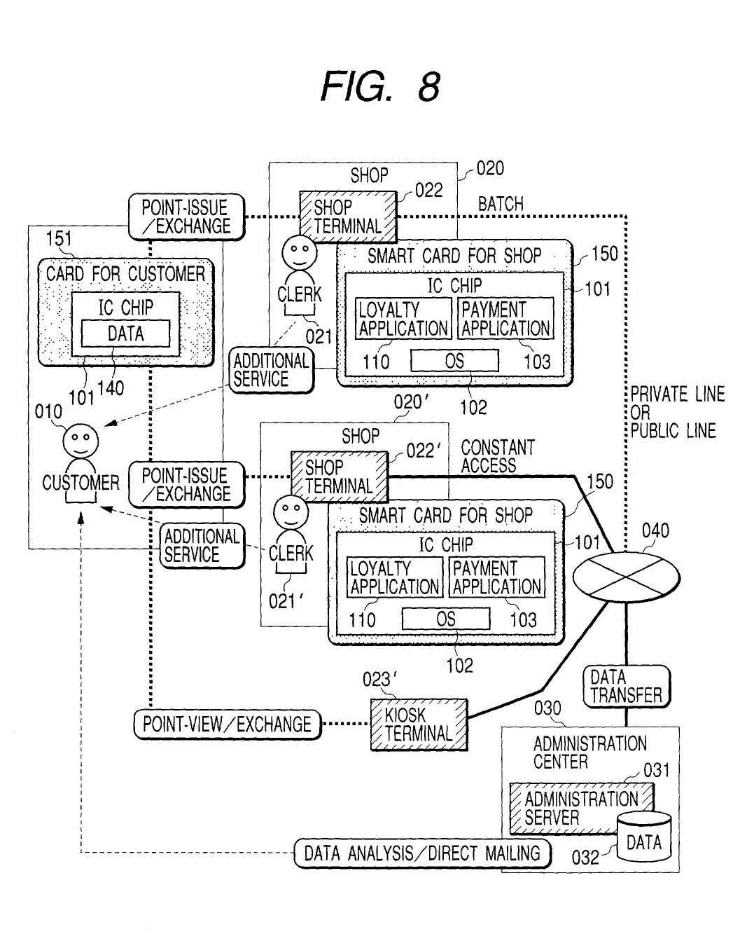

The following describes another example of the loyalty program using the smart card with reference to FIGS. 8 through 10.

The loyalty program using the smart card may use a shop-use smart card owned and managed by the shop in addition to customers' smart cards. Like an ordinary smart card installed with the multiapplication OS, a smart card for shop (150) contains application programs such as a loyalty application (110), a payment application (103), etc. running on an OS (102). In this case, the smart card for shop (150) implements the point management capability. A card for customer (151) just stores related data (140). It is sufficient to use a simple memory card without OS such as a smart card for data storage or a magnetic card capable of storing data. Obviously, in order to use other applications on the smart card or ensure high security, it is desirable to install the OS on the card for customer (151). Generally, a smart card installed with the multiapplication OS is intelligent, but is costly. The use of many low-cost cards for customers effectively saves costs for the entire system.

In this example, the smart card for shop (150) uses the shop terminal (022) for access, manages issuance of points to customers, and stores log data for transaction and point issuance as needed. If the log data stored in the smart card for shop is sent to the administration server, the shop terminal need not be always connected to the server. The smart card for shop (150) need not necessarily be shaped into a plastic card. It may be formed into a replaceable IC chip. There are the paid-in-advance point system and the paid-later point system. In the paid-in-advance point system, an issuable point amount is loaded into the smart card for shop (150) in advance. When a point is issued, the point amount issued to the card for customer (151) is subtracted from the smart card for shop (150). In the paid-later point system, the card records a point amount each time a point is issued and the amount is adjusted later. In either case, by using the smart card for shop, it is possible to manage the total amount of points issued to customers from the shop and prevent a clerk from illegally issuing points. Further, there is an effect of decreasing loads to a shop terminal itself by storing log data in the smart card for shop.

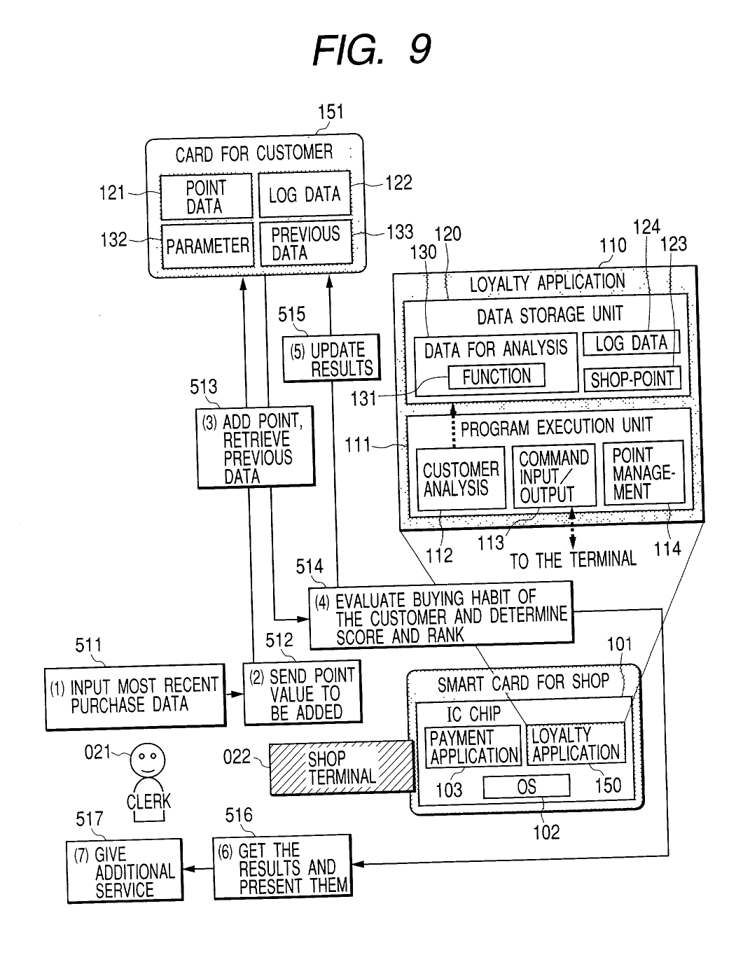

FIG. 9 shows a configuration for providing the loyalty application (110) of the smart card for shop (150) with a capability of analyzing the customer information.

The smart card for shop (150) is loaded with the loyalty application (110) and the payment application (103) running on the multiapplication-compliant OS (102). The loyalty application (110) comprises the program execution unit (111) and the data storage unit (120). The program execution unit (111) comprises the customer analysis unit (112), the command input/output unit (113), and the point management unit (114). The data storage unit (120) stores the data for customer data analysis (130), shop-point data (123), and transaction log data (124) at the shop. The data for customer data analysis (130) contains a function unit (131) for defining mathematical formulae. Here, the shop-point data (123) is equivalent to shop-issuable point data in the paid-in-advance point system or data about points issued so far by the shop in the paid-later point system.

The card for customer (151) stores the point data (121), the parameter data (132) for customer information analysis, the previous calculation result data (133), and the minimum log data (122).

The procedure is described below.

Step 1 (511): At the time of shopping, the clerk (021) enters purchase data (sales amount, amount of points provided, usage date, shop data, etc.) on the shop terminal (022).

Step 2 (512): The shop terminal (022) sends a point amount calculated from the most recent usage data to the card for customer (151).

Step 3 (513): The shop terminal adds the point to the card for customer (151) and retrieves the previous data (133) stored in the cared.

Step 4 (514): The smart card for shop (150) analyzes the customer information by using the previous calculation result received from the card (151) and the most recent purchase data to determine a customer rank.

Step 5 (515): The previous data is updated in the card for customer (151).

Step 6 (516): The shop terminal (022) obtains the result and displays it.

Step 7 (517): The clerk (021) provides the customer with an additional service according to the displayed result.

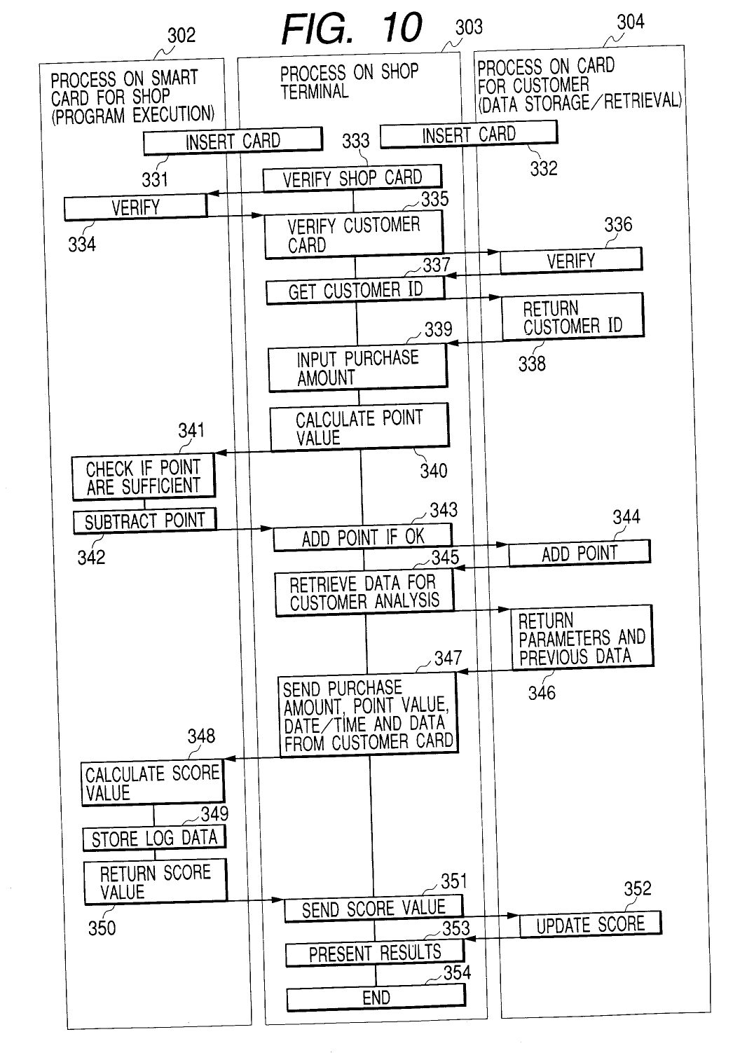

Referring to FIG. 10, the following describes a flow of providing points through the use of the smart card for shop shown in FIG. 9. Here, a process on the smart card for shop (302) is equivalent to program execution. A process on the smart card for shop (304) is equivalent to reading or writing data. A process on the shop terminal (303) triggers execution of the process on the smart card for shop (302) and the process on the smart card for shop (304).

At the time of processing, the smart card for shop (150) is inserted into the shop terminal (202). The smart card for shop need not be inserted or ejected for each processing and may be inserted in advance. When a customer uses the shop, the card for customer (151) is inserted into the shop terminal (022) (step 332). Before processing, the shop terminal verifies the smart card for shop (steps 333 and 334) and the smart card for customer (steps 335 and 336) to obtain the customer ID from the smart card for customer (steps 337 and 338). The shop terminal inputs a purchase amount (step 339), calculates a point amount from the input purchase amount (step 340), and checks if the smart card for shop is sufficient for the point to be provided (step 341). If the smart card for shop keeps sufficient points, the point amount is subtracted from the smart card for shop (step 342). When the process succeeds, the shop terminal adds the point to the smart card for customer (steps 343 and 344). The shop terminal obtains data such as parameters for analyzing the customer information and the previous calculation result from the smart card for customer (steps 345 and 346), and sends this data and the most recent purchase data to the smart card for shop (step 347). The smart card for shop calculates the most recent score (a value representing the customer's buying habit) according to the processes in FIG. 5 (step 348), stores the log data (step 349), and then returns the score (step 350). When receiving the result, the shop terminal writes the score in the smart card for customer (steps 351 and 352), displays the result (step 353), and terminates the process (step 354).

There has been described the calculation method of analyzing the customer information in the smart card for shop by using the example with reference to FIGS. 8 through 10.

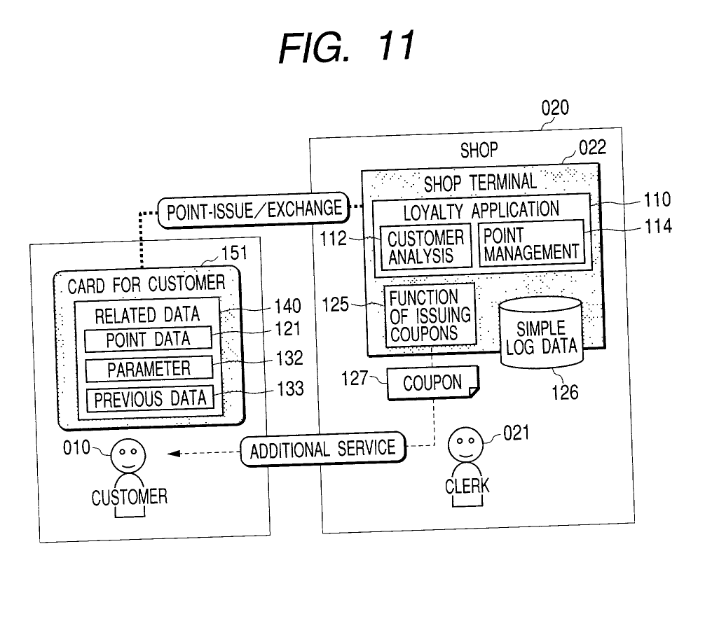

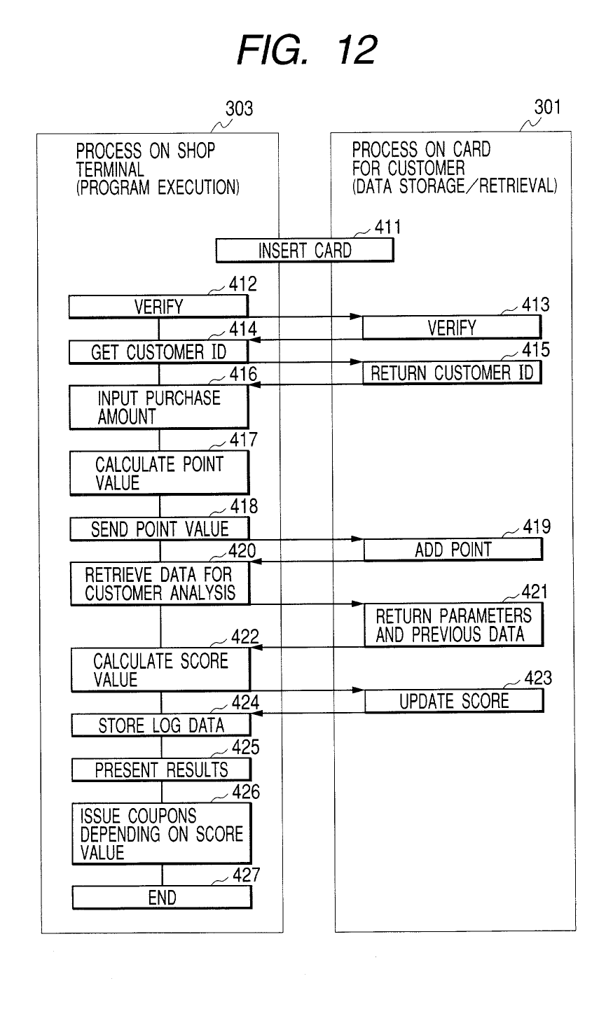

FIGS. 11 and 12 are used to explain yet another example of the loyalty program according to the present invention. In this example, like the system described in FIGS. 8 through 10, the card for customer (151) need not be a smart card and just needs to have a capacity enough to store the related data (140) such as the point data (121), a parameter (132) for analyzing the customer information, and previous data (133) as a calculation result. Obviously, the use of a smart card improves functionality and security. It is desirable to use a smart card for the card for customer (151). However, many cards are needed for customers, increasing costs. Card types should be selected according to costs of the cards to be used. In this example, the shop terminal (202) is installed with a program for managing points and analyzing the customer information. As shown in FIG. 8, an application program running on a smart card containing an IC chip provided with a CPU conveniently provides high-level security and easy maintenance of the program and files stored in the card.

Like the examples explained so far, a customer analysis capability (112) of the loyalty application (110) installed in the shop terminal (202) analyzes the customer information according to the method as shown in FIGS. 3 and 4. According to an analysis result, a function of issuing coupons (125) provides the customer with an additional service such as issuing an appropriate coupon (127). Of course, this function is capable of ordinary services such as providing or exchanging points. The shop terminal stores data about providing or exchanging points and a customer analysis result in a simple log data (126) and adjusts points to be issued or reorganizes the log data.

FIG. 12 shows a flow of processing for providing points. When a smart card is inserted into the shop terminal (step 411), the terminal performs authentication of the card (steps 412 and 413) to obtain the customer ID (steps 414 and 415). The shop terminal then inputs a purchase amount (step 416) determines a point value (step 417) based on the input purchase amount, and adds the point amount to the card (steps 418 and 419). The shop terminal retrieves customer analysis parameters needed for analyzing customers and the previous calculation result from the card for customer (steps 420 and 421) and calculates the most recent score value (step 422). The shop terminal writes this result on the card (step 423) stores the log data (step 424), and displays the result (step 425). Using the function of issuing coupons, the shop terminal issues a specified coupon (step 426) and terminates processing (step 427).

This example is suited for a relatively small-scale system and is characterized in that the shop terminal (202) is not connected to the administration server. The system does not require a large amount of memory for analyzing the customer information on the terminal. The system can satisfy a demand for easily and realtime determining valued customers, short of large-scale analysis of the customer information on the server, and save costs for introducing the system. When shop terminals are provided with the same loyalty application (110) for customer information analysis, the customer card can be used commonly at different shops. The system can be easily introduced into a local shopping center.

There has been described the customer relationship management system according to the present invention by using several examples.

According to the embodiments of the present invention as mentioned above, the application program in the smart card can analyze the customer information. The shop can realtime find each customer's buying habit without connection to the server. By using the recurrence formula for calculation in the card, the analysis is available just by using minimum data. The analysis can be easily implemented on a smart card having small memory capacity.

Compared to conventional analysis methods on the server, the method of analyzing customer information according to the embodiments of the present invention excels in realtime processing and saves communication costs. The method is especially effective for a common loyalty program with which a plurality of different shops is affiliated.

The embodiments of the present invention can differentiate customers at levels which are impossible for the conventional categorization based on just the yearly purchase amount. For example, fine-tuned customer services can be provided for a customer who often visits the shop recently (considered to be lavish presently) or a customer who continuously visits the shop.

According to the embodiments of the present invention, it is possible to improve customer services by using the loyalty program as a tool for retaining customers to conveniently provide results of analyzing the usage status and tendency of individual customers.

Appendices:

1. A smart card characterized in that a customer having a smart card uses a shop or service in conjunction with the n-th usage of the card (where n is a positive integer); it is assumed that Pn indicates purchase data for said smart card, tn indicates a time point for usage, and Sn (S0=0) is a value (score) representing customer's buying habit up to that time point; and the smart card contains a means for calculating said score Sn at said tn from at least said Pn and score Sn-l which is next to the most recent usage.

2. The smart card according to appendix 1 characterized by using at least one type of information such as the number of usage, a purchase amount, a usage date/time, and a usage category as said purchase data.

3. A smart card characterized by having an application program running on a smart card containing an IC chip provided with a CPU, a storage means, and an I/O interface, wherein said application program receives purchase data about the most recent usage from said I/O interface when a customer having said smart card uses a shop or a service; allows said CPU to calculate a value representing said customer's buying habit up to the most recent usage according to a specified mathematical formula based on a previous analysis result stored in said storage means and said previous purchase data; and sends a calculation result as needed via said I/O interface.

4. The smart card according to appendix 3 characterized by maintaining at least one parameter used for calculating a value representing said buying habit in said smart card, and maintaining at least one type of calculation results using different parameters in said smart card.

5. A customer relationship management system characterized in that, when a customer uses a shop or a service, said system analyzes a buying habit from said customer's purchase data to determine a customer rank and is provided with a smart card having a storage means and an I/O interface and with a terminal for communication with said card, wherein when a customer having said card uses a shop or a service, said terminal reads said customer's previous analysis result stored in said card, receives information about the most recent usage from outside, calculates a value representing said customer's buying habit so far according to a recurrence formula using a previous analysis result and the most recent purchase data, displays said calculation result, and re-stores said calculation result in said card.

6. A method of offering results of customer analysis characterized by, at the time of usage of a shop or a service by a customer, analyzing said customer's buying habit from his or her purchase data; determining a customer rank; displaying a determined result; using a smart card containing an IC chip having a CPU, a storage means, and an I/O interface and a terminal for communication with said smart card to receive information about the most recent usage by said customer in said smart card via said I/O interface; calculating a value representing said customer s buying habit so far from an analysis result at the previous usage and the most recent purchase data; and displaying a result of customer information analysis according to a procedure for sending a calculation result via said I/O interface.

What is claimed is:

1. A customer relationship management system where, at the time of usage of a shop or a service by a customer, said system analyzes said customer's buying habit to determine a customer rank from his or her purchase data and comprises a smart card containing an IC chip having a CPU, a storage means, and an I/O interface and a terminal for communication with said smart card,
wherein said smart card receives information about the most recent usage by said customer via said I/O interface, calculates a value representing said customer's buying habit so far from an analysis result at the previous usage and the most recent purchase data, and sends a calculation result as needed via said I/O interface.

2. The customer relationship management system according to claim 1, wherein the system has a capability to present a service content for said customer on said terminal according to a value representing said customer's buying habit calculated in a smart card.

3. The customer relationship management system according to claim 1, wherein the system uses at least one type of information such as the number of usage, a purchase amount, a usage date/time, and a usage category as said purchase data.

4. The customer relationship management system according to claim 1, wherein the system maintains at least one parameter used for calculating a value representing said buying habit in said smart card, and maintains at least one type of calculation results using different parameters in said smart card.

5. A customer relationship management system where, at the time of usage of a shop or a service by a customer, said system analyzes said customer's buying habit to determine a customer rank from his or her purchase data and comprises a smart card containing an IC chip having a CPU, a storage means, and an I/O interface and a terminal for communication with said smart card,
wherein said smart card has a capability to manage points provided when a customer having said smart card uses a shop or a service; said customer is provided with a specified service according to said point value; and said smart card receives information about the most recent usage by said customer via said I/O interface, calculates a value representing said customer's buying habit so far from an analysis result at the previous usage and the most recent purchase data, and varies a rate of providing said points according to said calculation result.

6. The customer relationship management system according to claim 5, wherein the system uses at least one type of information such as the number of usage, a purchase amount, a usage date/time, and a usage category as said purchase data.

7. The customer relationship management system according to claim 5, wherein the system maintains at least one parameter used for calculating a value representing said buying habit in said smart card, and maintains at least one type of calculation results using different parameters in said smart card.

8. A customer relationship management system where, at the time of usage of a shop or a service by a customer, said system analyzes said customer's buying habit to determine a customer rank from his or her purchase data and comprises at least two smart cards each containing an IC chip having a CPU, a storage means, and an I/O interface and a terminal for communication with said smart card,
wherein each customer owns at least one said first smart card (customer card); said first smart card is provided with at least one of a payment capability and a point management capability; said storage means stores a value representing said customer's buying habit so far; a shop owns said second smart card (shop card); said second smart card has a capability of calculating a value representing each customer's buying habit; and said second card, when used, receives a value representing said customer s buying habit so far from said first card via said I/O interface, uses said CPU to calculate a value representing said customer's buying habit according to a specified mathematical formula based on the previous log data and the most recently received purchase data, and then returns said calculation result to the customer card via said I/O interface.

9. The customer relationship management system according to claim 8, wherein the system uses at least one type of information such as the number of usage, a purchase amount, a usage date/time, and a usage category as said purchase data.

10. The customer relationship management system according to claim 8, wherein the system maintains at least one parameter used for calculating a value representing said buying habit in said smart card, and maintains at least one type of calculation results using different parameters in said smart card.
